(19) United States
(12) Patent Application Publication
(10) Pub. No.: US 2022/0329603 A1
(43) Pub. Date: Oct. 13, 2022

(54) AUTO-SECURITY FOR NETWORK EXPANSION USING FORWARD REFERENCES IN MULTI-SITE DEPLOYMENTS

(71) Applicant: VMWARE, Inc., Palo Alto, CA (US)

(72) Inventors: BHAGYASHREE GUJAR, Pune (IN); Sachin Mohan Vaidya, Pune (IN); Ujwala Kawalay, Pune (IN); Anand Loni, Pune (IN); Prayas Gaurav, Pune (IN)

(21) Appl. No.: 17/333,072

(22) Filed: May 28, 2021

(30) Foreign Application Priority Data
Apr. 7, 2021 (IN) 202141016372

(51) Int. Cl. H04L 29/06

(52) U.S. Cl. CPC H04L 63/104; H04L 63/0263; H04L 63/102; H04L 63/0272

(57) ABSTRACT

The disclosure provides an approach for managing group membership in a multi-site networking environment. Embodiments include receiving, at a local management component on a networking site of a plurality of networking sites, from a global management component associated with the plurality of networking sites, a definition of a group. Embodiments include determining, by the local management component on the networking site, based on the definition, that the group comprises a networking object with a span that does not include the networking site. Embodiments include storing, by the local management component on the networking site, in a data structure, a reference to the networking object in association with the group, wherein the networking object is excluded from a determination of local membership of the group on the networking site.

### RELATED APPLICATIONS

Benefit is claimed under 35 U.S.C. 119(a)-(d) to Foreign Application Serial No. 202141016372 filed in India entitled “AUTO-SECURITY FOR NETWORK EXPANSION USING FORWARD REFERENCES IN MULTI-SITE DEPLOYMENTS”, on Apr. 7, 2021, by VMware, Inc., which is herein incorporated in its entirety by reference for all purposes.

### BACKGROUND

A data center in a software defined networking (SDN) environment may comprise a plurality of hosts in communication over a physical network infrastructure. Each host is a physical computer (machine) that may run one or more virtualized endpoints such as virtual machines (VMs), containers, and/or other virtual computing instances (VCIs). In some cases, VCIs are connected to software-defined networks (SDNs), also referred to herein as logical overlay networks, which may span multiple hosts and are decoupled from the underlying physical network infrastructure.

Some SDN environments may include multiple data centers, and may be referred to as multi-site networking environments. It is often useful to define groups of entities in multi-site environments for use in applying policies, such as security policies, to the groups across different data centers. Entities in a group may include, for example, various types of VCIs and/or networking objects, as further discussed herein. Accordingly, if a policy is applied to a group, then the policy may be automatically applied to each entity that is a member of the group automatically, and potentially across multiple data centers, thereby simplifying the process of applying policies to entities.

A group may be defined at a global level, meaning that it is defined not for a particular data center, but rather globally such that it can be applied to any data center in a multi-site networking environment. In some cases, a group may include entities that are not yet defined for a particular data center to which the group is applied. Thus, when such a globally defined group is applied to a particular data center, it may be difficult to determine the membership of the group on the particular data center if the group includes entities that are not implemented on the particular data center. Existing techniques for managing group membership in multi-site networking environments may disregard a group on a given data center if the group includes a member that is not implemented on the given data center, thus causing policies involving the group to not be applied on the given data center.

Accordingly, there is a need in the art for improved techniques for managing group membership in multi-site networking environments.

### BRIEF DESCRIPTION OF THE DRAWINGS

FIG. 1 depicts example physical and virtual network components with which embodiments of the present disclosure may be implemented.

FIG. 2 is a diagram illustrating management of group membership in a multi-site networking environment.

FIG. 3 illustrates a data structure related to managing group membership in a multi-site networking environment.

FIG. 4 depicts example operations related to managing group membership in a multi-site networking environment.

FIG. 5 depicts additional example operations related to managing group membership in a multi-site networking environment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for managing group membership in a multi-site networking environment. A global group manager may enable the definition of groups of entities in a multi-site networking environment. For instance, a group may be a security group that is used to combine a plurality of entities for the purpose of defining security policies that are applicable to all of the entities together (e.g., rules restricting communication between members of a first group and members of a second group, limiting access by members of a given group to endpoints outside of a local network, and/or the like). Entities in a group may include, for example, VCIs and/or networking objects such as logical switches and logical ports. A networking object generally refers to a logical construct in an SDN environment that implements functions related to operation of the network, such as connecting VCIs together or facilitating communication between VCIs. A networking object may itself be implemented as one or more VCIs. Logical switches, for example, create logical broadcast domains or segments to which an application or VM can be logically wired. Logical ports provides logical connection points to various types of destinations, such as logical switches, logical routers, and external networks. Logical switches, logical routers, etc., may be implemented on one or more physical devices as one or more virtual switches, virtual routers, etc., as is known in the art. For example, any arbitrary set of VMs in a datacenter may be placed in communication across a logical Layer 2 network by connecting them to a logical switch. Each logical switch corresponds to a virtual network identifier (VNI). A logical switch is collectively implemented by at least one virtual switch on each host that has a VM connected to the logical switch. The virtual switch on each host operates as a managed edge switch implemented in software by the hypervisor on each host.

A data center generally refers to a centralized facility where computers, network, storage, and other equipment that support operations of an organization reside. While data centers are generally physical facilities comprising physical host computers connected over a physical networking infrastructure, a data center may also be a software-defined data center that abstracts physical resources of computing devices. In certain aspects, any networks internal to a given data center are isolated from any networks outside the data center, in that any communication between devices with a data center and devices outside the data center, such as in another data center) occur via one or more gateways associated with the data center. Accordingly, each data center may have one or more respective gateways for communications between the data center and network locations outside of the data center. A data center (accessible by a corresponding gateway) will have its own span, and all entities (e.g., VCIs, networking objects, and the like) created under the data center, such as networking objects, will extend the same span. A span of an entity refers to the set of data centers on which the entity is realized.

A networking object can be added as a member of a group. Similarly policies can be defined with respect to groups and/or networking objects, thus creating dependencies between the spans of the networking objects, groups, and policies.

Certain networking objects may potentially span multiple data centers, and the span of networking objects can change over time. For instance, the span of a logical switch may initially include only a first data center, but may be expanded to include a second data center at a later time. A group may also span multiple data centers, and generally may include networking objects with spans that are less than or equal to the span of the group. Thus, a group spanning a first and second data center may include a networking object that spans only the first data center. When such a group is distributed by the global group manager to a local group manager on the second data center, the local group manager on the second data center will determine that the group includes a networking object that does not exist on the second data center. While conventional techniques would have the group discarded on the second data center when the networking object cannot be resolved, embodiments of the present disclosure provide improved techniques in which a forward reference is used to manage group membership on a given data center in cases where a group includes a member that is not implemented on the given data center.

In certain embodiments, if a local group manager on a given data center receives a definition of a group that spans the given data center and includes a networking object with a span that does not include the given data center, the local group manager stores a forward reference to the networking object in association with the group. A “forward reference” may be a global identifier of the networking object associated with a global identifier of the group, and may be stored in a data structure such as a table. The membership of the group may then be determined for the given data center without considering the networking object, and any policies applicable to the group will then be applied on the given data center based on the local membership of the group. Subsequently, if the local group manager on the given data center determines that the span of the networking object has changed to include the given data center, then the forward reference may be deleted, and the membership of the group on the given data center may be re-determined with the inclusion of the networking object.

Accordingly, embodiments of the present disclosure constitute an improvement over existing techniques for managing group membership in multi-site systems by allowing groups and associated policies to be realized on data centers even if the groups include members that are not currently realized on the data centers. Furthermore, if the span of a networking object expands over time to include additional data centers in the span of a group of which the networking object is a member, any policies applicable to the group will already be applied at the additional data centers according to techniques described herein, thus improving the security and functionality of the networking environment.

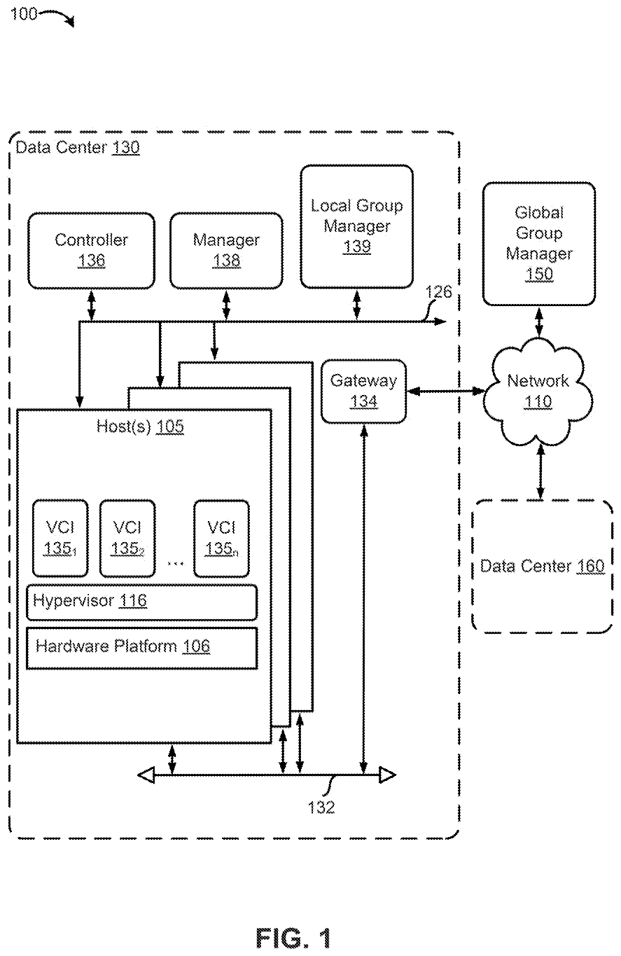

FIG. 1 depicts example physical and virtual network components with which embodiments of the present disclosure may be implemented.

Networking environment 100 includes data centers 130 and 160 and a global group manager 150 connected to network 110. Network 110 is generally representative of a network of machines such as a local area network (“LAN”) or a wide area network (“WAN”), a network of networks, such as the Internet, or any connection over which data may be transmitted.

Each of data centers 130 and 160 generally represents a set of networked machines and may comprise a logical overlay network. Data center 160 may include similar components to those depicted in data center 130. Data center 130 includes host(s) 105, a gateway 134, a data network 132, which may be a Layer 3 network, and a management network 126. Host(s) 105 may be an example of machines. Data network 132 and management network 126 may be separate physical networks or different virtual local area networks (VLANs) on the same physical network.

It is noted that, while not shown, additional data centers may also be connected to data center 130 and data center 160 via network 110. Communication between the different data centers may be performed via gateways associated with the different data centers.

Each of hosts 105 may include a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 for multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like. VCIs 135 may be an example of machines.

In certain aspects, hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Gateway 134 provides VCIs 135 and other components in data center 130 with connectivity to network 110, and is used to communicate with destinations external to data center 130. Gateway 134 may be implemented as one or more VCIs, physical devices, and/or software modules running within one or more hosts 105.

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user. In some embodiments, manager 138 determines membership of groups, such as security groups, for data center 130 based on group definitions received from global group manager 150 and/or based on information received from local group manager 139.

Local group manager 139 performs operations related to managing local group membership for data center 130, particularly for groups defined globally (e.g., at global group manager 150).

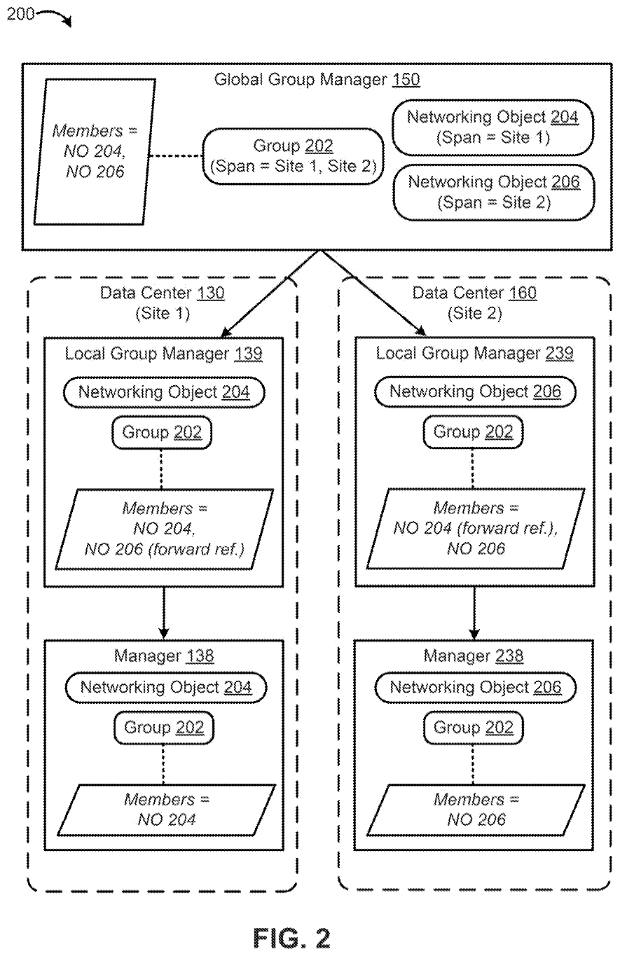

Global group manager 150 generally represents a centralized management component for groups in a multi-site environment comprising data centers 130 and 160 (and, in some embodiments, additional data centers that are not shown). Global group manager 150 may allow a user to define groups of entities in the networking environment and policies that reference those groups. In an example, global group manager 150 provides a user interface by which a user is able to indicate one or more conditions for membership in a group and define policies applicable to the group, such as security policies. A group definition may also specify the span of the group, indicating which data centers in the multi-site networking environment the group is to be implemented on. As described in more detail below with respect to FIG. 2, the span of a networking object in a group may potentially be smaller than the span of the group. As such, techniques described herein involve the use of forward references to manage group membership on local group managers.

FIG. 2 is a diagram 200 illustrating management of group membership in a multi-site networking environment. Diagram 200 includes global group manager 150, data centers 130 and 160, local group manager 139, and manager 138 of FIG. 1. Diagram 200 also includes local group manager 239 and manager 238, which perform similar functions for data center 160 to those performed by local group manager 139 and manager 138 for data center 130.

At global group manager 150, a group 202 is defined to have a span of site 1 (data center 130) and site 2 (data center 160), and is defined to include as members networking objects 204 and 206. For example, a user may have configured group 202 via a user interface, and may have directly indicated that networking objects 204 and 206 are members of group 202 or may have specified one or more conditions for membership in group 202 (conditions which networking objects 204 and 206 meet). Networking objects 204 and 206 may be any sort of networking object capable of spanning multiple sites. It is noted that while certain embodiments described herein involve networking objects being members of groups, other embodiments may include different types of entities being included in groups. For example, techniques described herein for using forward references to manage group membership in multi-site networking environments may be applied to any sort of entities that may be included in a group and that may potentially span multiple sites.

Networking object 204 has a span of site 1 (data center 230) and networking object 206 has a span of site 2 (data center 160). The spans of networking objects 204 and 206 both have the potential of later expanding to include additional data centers.

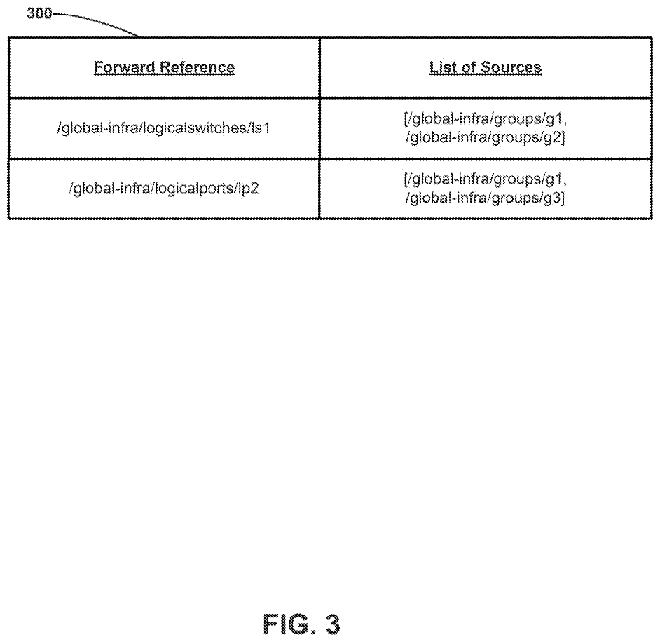

Networking object 204 is present on data center 130 because data center 130 is in the span of networking object 204, while networking object 206 is not present on data center 130. Similarly, networking object 206 is present on data center 160, but networking object 204 is not present on data center 160. When local group manager 139 in data center 130 receives the definition of group 202 from global group manager 150, it attempts to locate all members of the group based on identifiers of the members (e.g., which may be paths, as described with respect to FIG. 3). Local group manager 139 determines that one of the members of group 202 (networking object 206) is not present on data center 130 (e.g., when it is unable to resolve a path of networking object 206, determining that a target of the path does not exist). As such, local group manager 139 stores a forward reference to networking object 206 in association with group 202. Similarly, when local group manager 239 in data center 160 receives the definition of group 202 from global group manager 150, it determines that one of the members of group 202 (networking object 204) is not present on data center 160. As such, local group manager 239 stores a forward reference to networking object 204 in association with group 202. As described in more detail below with respect to FIG. 3, forward references may be stored in a data structure such as a table, and may include global identifiers of networking objects associated with global identifiers of groups.

Thus, at local manager 139, the members of group 202 include networking object 204 and a forward reference to networking object 206. Likewise, at local manager 239, the members of group 202 include a forward reference to networking object 204 and networking object 206.

Group membership on data centers may be resolved at the management plane. Resolving membership of a group generally includes determining all of the individual entities that are members of a group, and may also include, in some embodiments, determining VCIs connected to networking objects included in the membership of a group. In some cases, the management plane resolves group membership by resolving the identifiers of each member of the group and, subsequently, determining any entities (e.g., VCIs connected to a logical switch) that make up the members of the group. For instance, if a group includes a logical switch, the group may also include, by extension, the VCIs that are connected to the logical switch. According to techniques described herein, resolving an identifier may comprise checking the data structure (e.g., the forward reference table) at local group manager 139 and, if the data structure includes an entry with the identifier, an exception may be thrown indicating that a forward reference was found (e.g., which indicates that the object represented by the identifier is not present on the data center). In the present case, manager 138 on data center 130 determines from local group manager 139 that one of the members of group 202 (networking object 206) is not present on data center 130, and is stored only as a forward reference by local group manager 139. As such, manager 138 excludes networking object 206 from consideration when it resolves the membership of group 202. Accordingly, on manager 138, the membership of group 202 includes only networking object 204, which may be resolved by manager 138 to one or more particular VCIs connected to networking object 204.

Similarly, manager 238 on data center 160 determines from local group manager 239 that one of the members of group 202 (networking object 204) is not present on data center 160, and is stored only as a forward reference by local group manager 239. As such, manager 238 excludes networking object 204 from consideration when it resolves the membership of group 202. Accordingly, on manager 238, the membership of group 202 includes only networking object 206, which may be resolved to one or more particular VCIs.

Thus, while conventional techniques may involve manager 138 discarding group 202 because it is unable to resolve networking object 206 and manager 238 discarding group 202 because it is unable to resolve networking object 204, techniques described herein allow membership of group 202 to be resolved on both manager 138 and manager 238 even though group 202 includes at least one member that is not present on each of data centers 130 and 160. Policies applicable to group 202 may then be applied at both data centers 130 and 160, thereby improving security and functionality of the multi-site networking environment.

Subsequently, if the span of networking object 204 changes to include data center 160 and/or if the span of networking object 206 changes to include data center 130, local manager 138 and/or 239 may delete the applicable forward reference and manager 138 and/or 238 may fully resolve the membership of group 202 with the inclusion of both networking objects 204 and 206. Accordingly, security policies are automatically applied to the added networking objects 204 and 206 in data centers 160 and 130, respectively, thereby avoiding a situations where security policies are not applied to added networking objects 204 and 206 in data centers 160 and 130.

FIG. 3 illustrates a data structure 300 related to managing group membership in a multi-site networking environment. For example, data structure 300 may be a forward reference table used by local group manager 139 and/or local group manager 239 of FIG. 2 to store forward references.

In each row of data structure 300, a global identifier of an entity (e.g., a networking object not present on the data center) is stored in association with a list of one or more groups that are “sources” of the forward reference, the groups being identified by global identifiers as well. Global identifiers may be implemented in a variety of different ways. As an example, data structure 300 shows paths being used as global identifiers. The first row in data structure 300 depicts the global identifier “/global-infra/logicalswitches/ls1” associated with a list of global identifiers “[global-infra/groups/g1, /global-infra/groups/g2]”. In this example, “global-infra” represents a root domain of a global group management infrastructure, “logicalswitches” represents a domain beneath the root domain that is associated with logical switches, “ls1” represents a particular logical switch within the “logicalswitches” domain, “groups” represents a domain beneath the root domain that is associated with groups, and “g1” and “g2” represent particular groups within the “groups” domain.

The second row in data structure 300 depicts the global identifier “/global-infra/logicalports/lp2” associated with a list of global identifiers “[global-infra/groups/g1, /global-infra/groups/g3]”. In this example, “logicalports” represents a domain beneath the root domain that is associated with logical ports, “lp2” represents a particular logical port within the “logicalports” domain, and “g3” represents a particular group within the “groups” domain.

In an example, data structure 300 is maintained by a local group manager of a given data center on which the logical switch ls1 and the logical port lp2 are not present. Thus, when the local group manager receives definitions of groups g1, g2, and g3, it stores forward references for ls1 and lp2 in data structure 300 in association with the groups to which each belongs, as shown in FIG. 3. Memberships of groups g1, g2, and g3 will be determined on the given data center with the exclusion of ls1 and lp2.

In an example, if a span of lp2 later changes to include the given data center, the second row of data structure 300 may be deleted, and memberships of groups g1 and g3 may be re-determined on the given data center with the inclusion of lp2. Likewise, if a span of ls1 later changes to include the given data center, the first row of data structure 300 may be deleted, and memberships of groups g1 and g2 may be re-determined on the given data center with the inclusion of ls1.

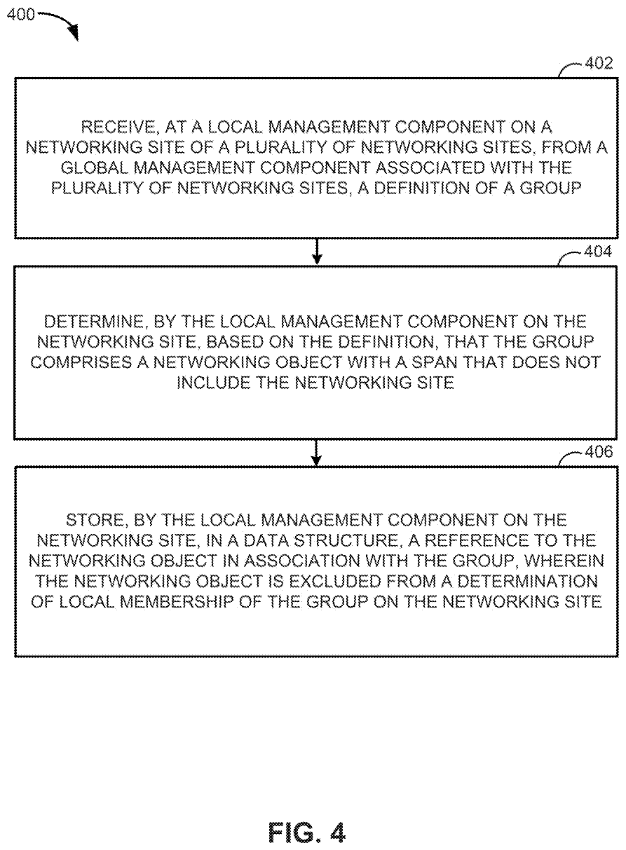

FIG. 4 depicts example operations 400 related to managing group membership in multi-site systems. For example, operations 400 may be performed by one or more components in networking environment 100 of FIG. 1, such as local group manager 139 and/or manager 138.

At step 402, a local management component, such as local group manager 139, on a networking site of a plurality of networking sites receives, from a global management component, such as global group manager 150, associated with the plurality of networking sites, such as data centers 130 and 160, a definition of a group.

At step 404, the local management component on the networking site, determines based on the definition, that the group comprises a networking object with a span that does not include the networking site. The networking object may be, for example, a logical switch, a logical port, or the like.

At step 406, the local management component on the networking site stores, in a data structure, a reference to the networking object in association with the group, wherein the networking object is excluded from a determination of local membership of the group on the networking site. Storing the reference to the networking object in association with the group may, for example, comprise storing a global identifier of the networking object in association with a global identifier of the group in the data structure. In certain embodiments, the data structure comprises a table that stores the reference to the networking object with a list of all groups of which the networking object is a member.

In some embodiments, the local management component on the networking site notifies a management plane of the networking site that the group comprises the networking object with the span that does not include the networking site, and the management plane performs the determination of the membership of the group on the networking site, excluding the networking object from the determination.

Certain embodiments further include applying, on the networking site, a security rule that relates to the group based on the local membership of the group.

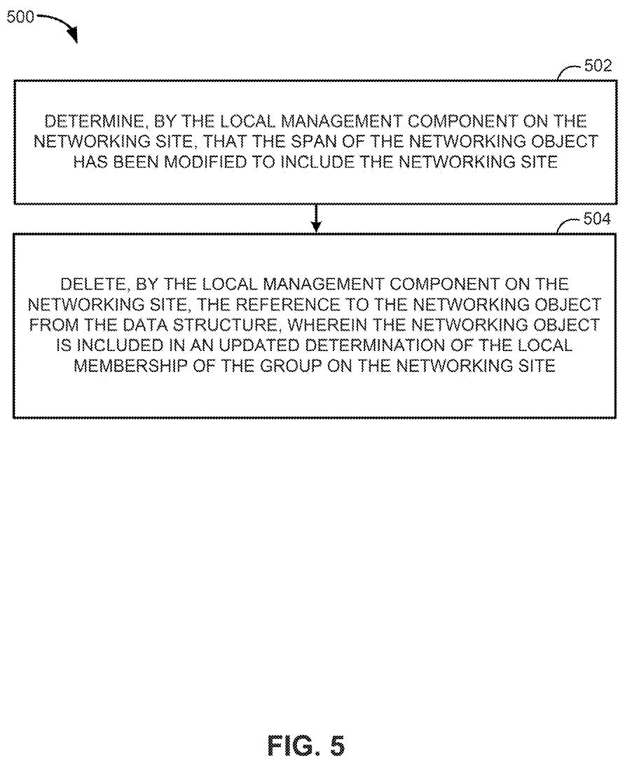

FIG. 5 depicts additional example operations 500 related to managing group membership in multi-site systems. For example, operations 500 may be performed by one or more components in networking environment 100 of FIG. 1, such as local group manager 139 and/or manager 138, and may be performed after operations 400 of FIG. 4.

At step 502, the local management component on the networking site determines that the span of the networking object has been modified to include the networking site.

At step 504, the local management component on the networking site deletes the reference to the networking object from the data structure, wherein the networking object is included in an updated determination of the local membership of the group on the networking site.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of managing group membership in a multi-site networking environment, comprising:
receiving, at a local management component on a networking site of a plurality of networking sites, from a global management component associated with the plurality of networking sites, a definition of a group;
determining, by the local management component on the networking site, based on the definition, that the group comprises a networking object with a span that does not include the networking site; and
storing, by the local management component on the networking site, in a data structure, a reference to the networking object in association with the group, wherein the networking object is excluded from a determination of local membership of the group on the networking site.

2. The method of claim 1, further comprising applying, on the networking site, a security rule that relates to the group based on the local membership of the group.

3. The method of claim 1, further comprising;
determining, by the local management component on the networking site, that the span of the networking object has been modified to include the networking site; and
deleting, by the local management component on the networking site, the reference to the networking object from the data structure, wherein the networking object is included in an updated determination of the local membership of the group on the networking site.

4. The method of claim 1, wherein the networking object comprises one of:
a logical switch; or
a logical port.

5. The method of claim 1, wherein storing, by the local management component on the networking site, in the data structure, the reference to the networking object in association with the group comprises storing a global identifier of the networking object in association with a global identifier of the group in the data structure.

6. The method of claim 1, further comprising notifying, by the local management component on the networking site, a management plane of the networking site that the group comprises the networking object with the span that does not include the networking site, wherein the management plane performs the determination of the membership of the group on the networking site.

7. The method of claim 1, wherein the data structure comprises a table that stores the reference to the networking object with a list of all groups of which the networking object is a member.

8. A system for managing group membership in a multi-site networking environment, comprising:
at least one memory; and
at least one processor coupled to the at least one memory, the at least one processor and the at least one memory configured to:
receive, at a local management component on a networking site of a plurality of networking sites, from a global management component associated with the plurality of networking sites, a definition of a group;
determine, by the local management component on the networking site, based on the definition, that the group comprises a networking object with a span that does not include the networking site; and
store, by the local management component on the networking site, in a data structure, a reference to the networking object in association with the group, wherein the networking object is excluded from a determination of local membership of the group on the networking site.

9. The system of claim 8, wherein the at least one processor and the at least one memory are further configured to apply, on the networking site, a security rule that relates to the group based on the local membership of the group.

10. The system of claim 8, wherein the at least one processor and the at least one memory are further configured to:
determine, by the local management component on the networking site, that the span of the networking object has been modified to include the networking site; and
delete, by the local management component on the networking site, the reference to the networking object from the data structure, wherein the networking object is included in an updated determination of the local membership of the group on the networking site.

11. The system of claim 8, wherein the networking object comprises one of:
a logical switch; or
a logical port.

12. The system of claim 8, wherein storing, by the local management component on the networking site, in the data structure, the reference to the networking object in association with the group comprises storing a global identifier of the networking object in association with a global identifier of the group in the data structure.

13. The system of claim 8, wherein the at least one processor and the at least one memory are further configured to notify, by the local management component on the networking site, a management plane of the networking site that the group comprises the networking object with the span that does not include the networking site, wherein the management plane performs the determination of the membership of the group on the networking site.

14. The system of claim 8, wherein the data structure comprises a table that stores the reference to the networking object with a list of all groups of which the networking object is a member.

15. A non-transitory computer-readable medium storing instructions that, when executed by one or more processors, cause the one or more processors to:
receive, at a local management component on a networking site of a plurality of networking sites, from a global management component associated with the plurality of networking sites, a definition of a group;
determine, by the local management component on the networking site, based on the definition, that the group comprises a networking object with a span that does not include the networking site; and
store, by the local management component on the networking site, in a data structure, a reference to the networking object in association with the group, wherein the networking object is excluded from a determination of local membership of the group on the networking site.

16. The non-transitory computer-readable medium of claim 15, wherein the instructions, when executed by one or more processors, further cause the one or more processors to apply, on the networking site, a security rule that relates to the group based on the local membership of the group.

17. The non-transitory computer-readable medium of claim 15, wherein the instructions, when executed by one or more processors, further cause the one or more processors to:
determine, by the local management component on the networking site, that the span of the networking object has been modified to include the networking site; and
delete, by the local management component on the networking site, the reference to the networking object from the data structure, wherein the networking object is included in an updated determination of the local membership of the group on the networking site.

18. The non-transitory computer-readable medium of claim 15, wherein the networking object comprises one of:
a logical switch; or
a logical port.

19. The non-transitory computer-readable medium of claim 15, wherein storing, by the local management component on the networking site, in the data structure, the reference to the networking object in association with the group comprises storing a global identifier of the networking object in association with a global identifier of the group in the data structure.

20. The non-transitory computer-readable medium of claim 15, wherein the instructions, when executed by one or more processors, further cause the one or more processors to notify, by the local management component on the networking site, a management plane of the networking site that the group comprises the networking object with the span that does not include the networking site, wherein the management plane performs the determination of the membership of the group on the networking site.
